(19) United States
(12) Patent Application Publication
(10) Pub. No.: US 2023/0186781 A1
(43) Pub. Date: Jun. 15, 2023

(54) VIRTUAL DRIVING SIMULATION DEVICE AND METHOD FOR IMPROVING SENSATION OF IMMERSION THEREFOR

(71) Applicants: Hyundai Motor Company, Seoul (KR); Kia Corporation, Seoul (KR)

(72) Inventors: Ki Chang Kim, Suwon (KR); Dong Chul Park, Anyang (KR); Eun Soo Jo, Hwaseong (KR); Tae Kun Yun, Anyang (KR)

(21) Appl. No.: 17/889,223

(22) Filed: Aug. 16, 2022

(30) Foreign Application Priority Data
Dec. 13, 2021 (KR) 10-2021-0178097

(51) Int. Cl. G09B 9/04; H04S 3/00; G06F 3/01

(52) U.S. Cl. CPC G09B 9/04; H04S 3/008; G06F 3/016; G06F 3/011; H04S 2420/11

(57) ABSTRACT

A virtual driving simulation device and a method for improving a sensation of immersion therefore that may improve the sensation of immersion for a driving simulation in a virtual environment includes a microphone for measuring a 3D sound, and a processor that is configured to record the 3D sound through the microphone, analyze a sound realization influence by reproducing the recorded 3D sound through higher-order ambisonics (HOA) encoding and HOA decoding, and realize the sensation of immersion based on a result of analyzing the sound realization influence.

### CROSS-REFERENCE TO RELATED APPLICATION

This application claims under 35 U.S.C. § 119(a) the benefit of priority to Korean Patent Application No. 10-2021-0178097, filed in the Korean Intellectual Property Office on Dec. 13, 2021, the entire contents of which are incorporated herein by reference.

### BACKGROUND

### Technical Field

The present disclosure relates to a virtual driving simulation device and a method for improving a sensation of immersion therefor that may improve the sensation of immersion for a driving simulation in a virtual environment.

### Background Description

A virtual reality (VR) system may be composed of a display device that displays a virtual space to a user, an input device that receives a movement of the user as an input, and a control device that changes the virtual space by reflecting the movement of the user input through the input device and outputs the changed virtual space on the display device. A sensation of immersion technology must be added between a virtual image and an interaction to implement a virtual environment in such a virtual reality system.

### SUMMARY

The present disclosure has been made to solve the above-mentioned problems occurring in the existing technologies while advantages achieved by the existing technologies may be maintained intact.

Embodiments of the present disclosure provide a virtual driving simulation device and a method for improving a sensation of immersion therefor that are configured to generate a sound corresponding to a virtual image to improve the sensation of immersion during a driving simulation in a virtual environment.

Embodiments of the present disclosure provide a virtual driving simulation device and a method for improving a sensation of immersion therefor that implement a motion and haptics based on a sound to improve the sensation of immersion during a driving simulation in a virtual environment.

The technical problems to be solved by the present disclosure may not be limited to the aforementioned problems, and any other technical problems not mentioned herein will be clearly understood from the following description by those skilled in the art to which the present disclosure pertains.

According to an embodiment of the present disclosure, a virtual driving simulation device may include a microphone for measuring a three-dimensional (3D) sound generated in association with a virtual environment experience through virtual reality (VR) system, and a processor that is configured to record the 3D sound through the microphone, analyze a sound realization influence by reproducing the recorded 3D sound through higher-order ambisonics (HOA) encoding and HOA decoding, and realize a sensation of immersion based on a result of analyzing the sound realization influence.

In an exemplary embodiment, the processor may is configured to convert a format of the data measured and/or generated by the microphone into a HOA format through the HOA encoding.

In one implementation, the HOA format may be a B-format containing non-directional sound information and 3D direction information.

In an exemplary embodiment, the processor may is configured to convert a first coordinate system of the data whose format may be converted into the HOA format into a second coordinate system of a speaker array through the HOA decoding.

In an exemplary embodiment, the processor may is configured to reproduce the sound that has undergone the HOA encoding and the HOA decoding using a head-related transfer function (HRTF).

In an exemplary embodiment, the virtual driving simulation device may further include a seat simulator for providing motions of 6 degrees of freedom, and the processor may is configured to tune the seat simulator based on a predetermined scenario, set a motion evaluation mode based on a sound-based scenario, and analyze a motion excitation influence through immersion evaluation by a multi modal excitation provided by the seat simulator in the set motion evaluation mode, and realize the sensation of immersion by reflecting a result of analyzing the motion excitation influence.

In an exemplary embodiment, the processor may is configured to set the motion evaluation mode in consideration of a seating posture.

In an exemplary embodiment, the processor may is configured to construct the virtual environment by tuning a haptic controller and a VR device, tune a haptic vibration profile intensity based on a visual change of the VR device, and analyze a haptic stimulus influence through sensation of immersion analysis on the tuned haptic vibration profile intensity, and realize the sensation of immersion by reflecting a result of analyzing the haptic stimulus influence.

In an exemplary embodiment, the processor may perform the sensation of immersion analysis using a headset where correction logic considering head rotation may be applied.

In an exemplary embodiment, the microphone may be implemented as a multi-channel microphone.

According to an exemplary embodiment of the present disclosure, a method for improving a sensation of immersion for a virtual driving simulation may include recording, by a processor, a 3D sound using a microphone for generation in a virtual environment, reproducing, by the processor, the recorded 3D sound through HOA encoding and HOA decoding, analyzing, by the processor, a sound realization influence through the reproduced sound, and realizing, by the processor, a sensation of immersion based on a result of analyzing the sound realization influence.

In one implementation, the reproducing of the recorded 3D sound may include converting a format of the data measured and/or generated by the microphone into a HOA format through the HOA encoding, and converting a first coordinate system of the data whose format may be converted into the HOA format into a second coordinate system of a speaker array through the HOA decoding.

In an exemplary embodiment, the HOA format may be a B-format containing non-directional sound information and 3D direction information.

In an exemplary embodiment, the reproducing of the recorded 3D sound may include reproducing a reproduced sound that has undergone the HOA encoding and the HOA decoding using a HRTF.

In an exemplary embodiment, the method may further include tuning a seat simulator for providing motions of 6 degrees of freedom based on a predetermined scenario, setting, with the processor, a motion evaluation mode based on a sound-based scenario, analyzing, with the processor, a motion excitation influence through immersion evaluation by a multi modal excitation provided by the seat simulator in the set motion evaluation mode, and realizing, with the processor, the sensation of immersion by reflecting a result of analyzing the motion excitation influence.

In an exemplary embodiment, the setting of the motion evaluation mode may include setting the motion evaluation mode in consideration of a seating posture.

In an exemplary embodiment, the method may further include constructing a virtual environment by tuning a haptic controller and a VR device, tuning a haptic vibration profile intensity based on a visual change of the VR device, analyzing a haptic stimulus influence through sensation of immersion analysis on the tuned haptic vibration profile intensity, and realizing the sensation of immersion by reflecting a result of analyzing the haptic stimulus influence.

In an exemplary embodiment, the analyzing of the haptic stimulus influence may include performing the sensation of immersion analysis using a headset where correction logic considering head rotation may be applied.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a virtual driving simulation system according to embodiments of the present disclosure.

FIG. 2 is a diagram schematically illustrating a virtual driving simulation construction process according to embodiments of the present disclosure.

FIG. 3 is a diagram for illustrating a virtual sound tuning process of a virtual driving simulation device according to embodiments of the present disclosure.

FIG. 4A is a diagram showing a result of sound tuning in an actual vehicle according to embodiments of the present disclosure.

FIG. 4B is a diagram showing a result of sound tuning in a virtual environment according to embodiments of the present disclosure.

FIG. 5 is a flowchart illustrating a method for improving a sensation of immersion for a virtual driving simulation according to embodiments of the present disclosure.

FIG. 6 is a diagram schematically illustrating a process of designing a sound corresponding to a virtual image according to embodiments of the present disclosure.

FIG. 7 is a diagram schematically illustrating a sound-based multi modal excitation process according to embodiments of the present disclosure.

FIG. 8 is a diagram schematically illustrating a sound-based haptic stimulus influence analysis process according to embodiments of the present disclosure.

FIG. 9 is a diagram illustrating a head rotation coordinate system according to embodiments of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component may be designated by the identical numeral even when they may be displayed on other drawings. Further, in describing the embodiment of the present disclosure, a detailed description of the related known configuration or function will be omitted when it may be determined that it interferes with the understanding of the embodiment of the present disclosure.

In describing the components of the embodiment according to the present disclosure, terms such as first, second, A, B, (a), (b), and the like may be used. These terms may be merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that may be consistent with their meaning in the context of the relevant art and will not be interpreted in an idealized or overly formal sense unless expressly so defined herein.

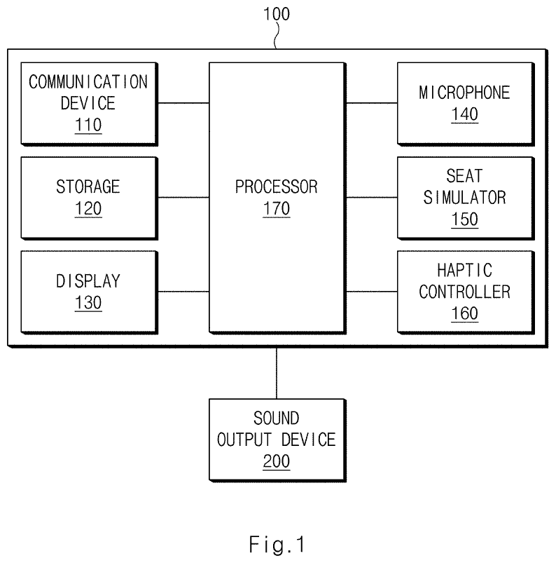

FIG. 1 is a block diagram illustrating a virtual driving simulation system according to embodiments of the present disclosure.

Referring to FIG. 1, a virtual driving simulation (VDS) system may include a virtual driving simulation device 100 and a sound output device 200.

The virtual driving simulation device 100 may be implemented separately from a device in a vehicle and may be connected to electronic control units (ECUs) of the vehicle by separate connection means. The virtual driving simulation device 100 may be implemented as an active sound design (ASD) hardware in loop simulation (HiLS).

The virtual driving simulation device (VDS device) 100 may include a communication device 110, storage 120, a display 130, a microphone 140, a seat simulator 150, a haptic controller 160, a processor 170, and the like. The virtual driving simulation device (VDS device) 100 may be used in communication with a vehicle.

The communication device 110 may support the VDS device 100 to communicate with the ECUs mounted on the vehicle. The communication device 110 may include a transceiver that transmits and receives data (information) using a vehicle communication technology such as a controller area network (CAN), an Ethernet, and the like.

The communication device 110 may support the VDS device 100 to perform wired communication and/or wireless communication with an external electronic device (e.g., a terminal, a server, and the like). For example, the communication device 110 may download a sound source through communication with a server that provides the sound source. The communication device 110 may include a wired communication circuit (e.g., a local area network (LAN) communication circuit and/or a powerline communication circuit) and/or a wireless communication circuit (e.g., a cellular communication circuit, a short-range wireless communication circuit, and/or a global navigation satellite system (GNSS) communication circuit).

The storage 120 may store and/or may comprise machine readable instructions and/or data including any combination of virtual driving simulation logic (VDS algorithm), virtual sound design algorithm (ASD algorithm), volume setting logic, volume control logic, and/or sound equalizer logic. The storage 120 may store a target profile, engine information (e.g., an RPM, a throttle, and/or a torque), and/or a performance sound.

The storage 120 may be a non-transitory storage medium that stores instructions and/or information executed and/or read by the processor 170. The storage 120 may include at least one of storage media such as a random access memory (RAM), a static random access memory (SRAM), a read only memory (ROM), a programmable read only memory (PROM), an electronically erasable and programmable ROM (EEPROM), an erasable and programmable ROM (EPROM), a hard disk drive (HDD), a solid state disk (SSD), an embedded multimedia card (eMMC), a universal flash storage (UFS), and/or web storage.

The display 130 may output a progress, a result, and the like of an operation of the processor 170 in a form of visual information. The display 130 may be implemented as at least one of output means such as a liquid crystal display (LCD), a thin film transistor-liquid crystal display (TFT-LCD), an organic light-emitting diode (OLED) display, a flexible display, a three-dimensional display (3D display), a transparent display, a head-up display (HUD), and/or a touch screen. When the display 130 may be implemented as the touch screen, the display 130 may be used as an input device as well as an output device.

The microphone 140 may be a microphone (an eigenmike) capable of measuring a three-dimensional sound that may be reproduced (generated) in the vehicle, that is, a 3D sound. The microphone 140 may be implemented as a 2-channel microphone, an 8-channel microphone array, and/or a 32-channel microphone array.

The seat simulator 150 may include 6-axis actuators to provide motions of 6 degrees of freedom. The seat simulator 150 may include a motion platform, and a seat and a cabin installed on the motion platform. The seat may be installed on the motion platform. The seat simulator 150 may perform motion device tuning based on a predetermined scenario. The seat simulator 150 may be set to drive a motion based on a parameter transmitted from the processor 170. The seat simulator 150 may include a motor controller that is configured to control a motor to operate the 6-axis actuators in the motion platform, a motion controller that controls the motion of the motion platform, and a motion computer. The motion computer may interface control and input data tuning, and perform data monitoring.

The haptic controller 160 may be configured to generate vibration based on sound. The haptic controller 160 may be configured to determine a pattern, an intensity, and the like of the vibration based on the sound. The haptic controller 160 may be configured to generate the vibration by controlling a vibrator based on the determined pattern and intensity of the vibration. At least one vibrator may be installed in each of a back and a cushion of the seat.

The processor 170 may be electrically connected to each of the components 110 to 160. The processor 170 may be configured to control an operation of each of the components 110 to 160. The processor 170 may include at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The processor 170 may be configured to realize the 3D sound, the motion (a movement and the vibration) and haptics (a tactile sense) to improve a sensation of immersion by utilizing the five senses in a virtual environment. The processor 170 may design a 3D sound matching the virtual environment. In other words, the processor 170 may generate a sound (a 3D sound) corresponding to a virtual image. The processor 170 may perform multi modal excitation based on the generated 3D sound. The processor 170 may output a tactile stimulus (the haptics) based on the generated 3D sound.

The processor 170 may be configured to generate the 3D sound based on surrounding environment information. That is, the processor 170 may be configured to design the sound corresponding to the virtual image. The processor 170 may be configured to generate the multi modal excitation by controlling the seat simulator 150 based on the generated sound. The processor 170 may be configured to receive active manipulation and feedback of a user during the multi modal excitation. The processor 170 may be configured to generate the tactile stimulus (a haptic signal) based on the generated sound and/or the active manipulation and the feedback of the user. The processor 170 may be configured to realize an ultra-realistic sensation of immersion based on driving environment information.

The processor 170 may be configured to receive driving information, for example, the RPM, the torque, a speed, and/or a throttle opening amount, transmitted from the electronic control unit (ECU) in the vehicle. The processor 170 may execute the ASD algorithm using the driving information and a pre-stored target profile as input data of the ASD algorithm. The ASD algorithm may generate an engine sound based on the driving information and the pre-stored target profile. The processor 170 may be configured to reproduce the engine sound generated by the ASD algorithm and output the engine sound through a vehicle speaker.

The processor 170 may be configured to generate a virtual sound from the engine sound generated by the ASD algorithm based on a head unit signal (a volume, a tone volume, and the like) and a performance signal (the driving information). In addition, the processor 170 may be configured to output the virtual sound by tuning a volume, a sound quality, and/or a tone of the generated virtual sound based on a user input received from a user interface.

The sound output device 200 may reproduce a sound source that may be pre-stored or streamed in real-time and output the sound source to the outside. The sound output device 200 may reproduce and output the virtual sound and/or the engine sound output from the processor 170. The sound output device 200 may include a sound reproducer, an amplifier, a speaker, and/or a headset. The amplifier may amplify an electrical signal of the sound reproduced by the sound reproducer. A plurality of speakers may be installed at different positions inside and/or outside the vehicle, and the electric signal amplified by the amplifier may be converted into a sound wave. The headset may be worn by the user seated in the seat.

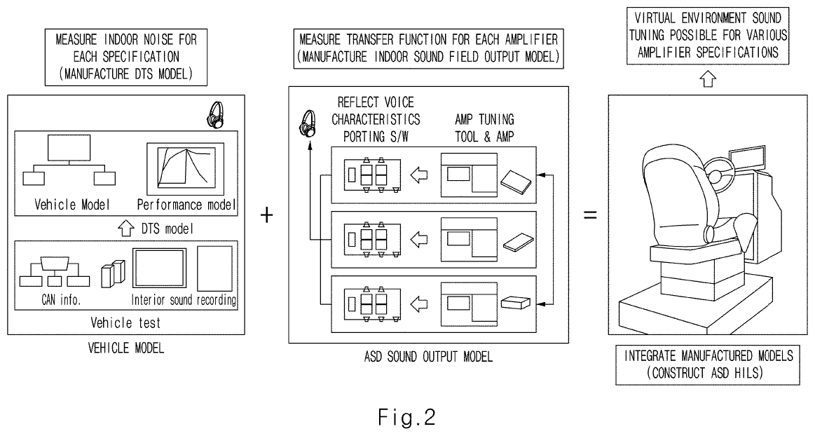

FIG. 2 is a diagram schematically illustrating a virtual driving simulation construction process according to embodiments of the present disclosure.

Referring to FIG. 2, a virtual driving simulation model (logic) may be developed through actual vehicle interior noise measurement data and measurement of a transfer function for each amplifier for an actual vehicle driving simulation in the virtual environment. Specifically, it may be possible to measure indoor noise for each vehicle specification and generate a vehicle model using the measured data. It may be possible to measure the transfer function for each amplifier and generate an indoor sound field output model, that is, an ASD sound output model, based on the measured transfer function for each amplifier. The virtual driving simulation model, that is, the ASD HiLS may be constructed by integrating the generated vehicle model and the ASD sound output model. The virtual driving simulation model may tune a virtual environment sound for various amplifier specifications.

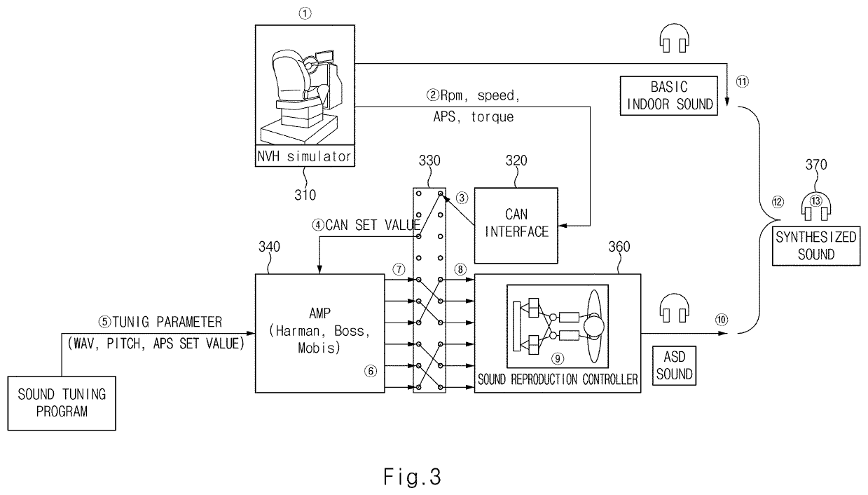

FIG. 3 is a diagram for illustrating a virtual sound tuning process of a virtual driving simulation device according to embodiments of the present disclosure.

Referring to FIG. 3, a noise, vibration, harshness (NVH) simulator 310 may sense a pressed amount of an accelerator pedal when the accelerator pedal may be manipulated (\textcircled{1}). The simulator 310 may calculate a parameter based on the pressed amount of the accelerator pedal (a parameter calculated from a simulator model) and transmit the calculated parameter to a CAN interface 320 (\textcircled{2}). The parameter may include an RPM, a speed, an accelerator pedal sensor (APS), and/or a torque.

The CAN interface 320 may transmit a CAN signal containing the parameter calculated by the simulator 310 to a connection terminal 330 (\textcircled{3}). The connection terminal 330 may transmit the CAN signal to an amplifier (AMP) 340 (\textcircled{4}). The AMP 340 may receive a tuning parameter of a sound tuning program 350 (\textcircled{5}).

The AMP 340 may calculate an output value based on the tuning parameter and the CAN signal (\textcircled{6}). The AMP 340 may transmit a calculated output signal to the connection terminal 330 (\textcircled{7}). The connection terminal 330 may transmit the output signal to a sound reproduction controller 360 (\textcircled{8}).

The sound reproduction controller 360 may convert the 6 to 7 output signals input from the connection terminal 330 into stereo signals (\textcircled{9}). The sound reproduction controller 360 may output a converted stereo sound (that is, an ASD sound) (\textcircled{10}).

The simulator 310 may output a sound (a basic indoor sound) recorded in the actual vehicle (\textcircled{11}). A headset 370 may synchronize the sound output from the simulator 310, that is, the basic indoor sound, with the stereo sound, that is, the ASD sound, output from the sound reproduction controller 360 in real time (\textcircled{12}). The headset 370 may output the synthesized stereo sound (a synthesized sound) (\textcircled{13}).

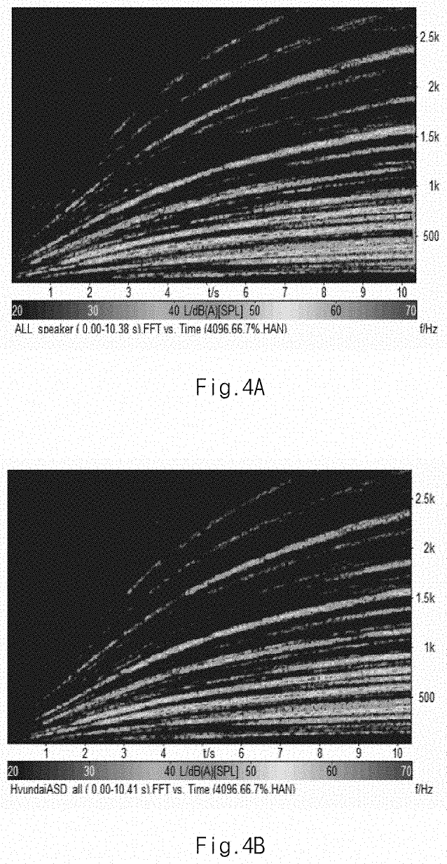

FIG. 4A is a diagram showing a result of sound tuning in an actual vehicle according to embodiments of the present disclosure, and FIG. 4B is a diagram showing a result of sound tuning in a virtual environment according to embodiments of the present disclosure.

For application for virtual environment sensation of immersion evaluation equipment, a verification test for a correlation between the actual vehicle and the virtual driving simulation system may be desired. Referring to FIGS. 4A and 4B, it may be identified that a sound of the same pattern as a sound pattern in the actual vehicle may be realized in the virtual driving simulation system as a result of performing an evaluation in the actual vehicle by fixing a position of a measurement ear in a stopped state.

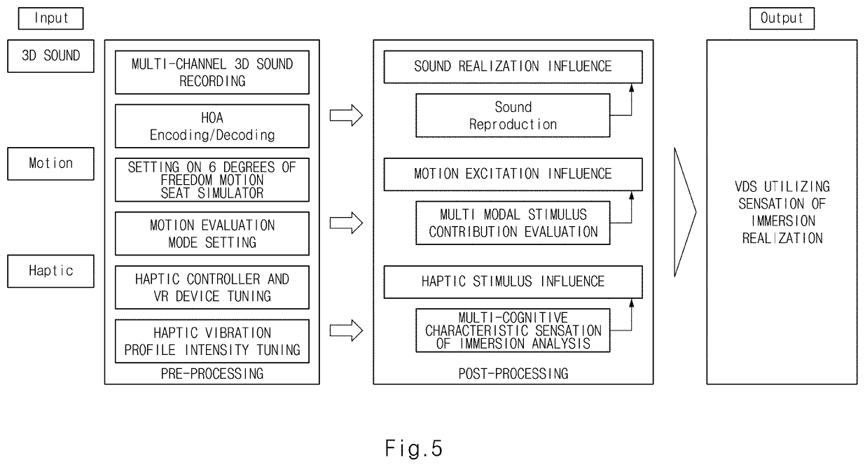

FIG. 5 is a flowchart illustrating a method for improving a sensation of immersion for a virtual driving simulation according to embodiments of the present disclosure.

Referring to FIG. 5, the processor 170 of the VDS device 100 may receive the 3D sound, motion information, and haptic information as input data.

The processor 170 may record the multi-channel 3D sound through the microphone 140. The processor 170 may reproduce the sound by performing higher-order ambisonics (HOA) encoding and decoding of the recorded sound. The processor 170 may analyze a sound realization influence.

The processor 170 may be set in the seat simulator 150 that provides the motions of the 6 degrees of freedom. The processor 170 may be set to be in a motion evaluation mode. The processor 170 may evaluate a multi modal stimulus contribution. The processor 170 may analyze a motion excitation influence based on the evaluation result.

The processor 170 may tune the haptic controller 160 and a VR device. The processor 170 may tune a haptic vibration profile intensity. The processor 170 may analyze a haptic stimulus influence by analyzing a multi-cognitive characteristic sensation of immersion.

The processor 170 may realize the sensation of immersion to be used in the virtual driving simulation based on the sound realization influence, the motion excitation influence, and the haptic stimulus influence.

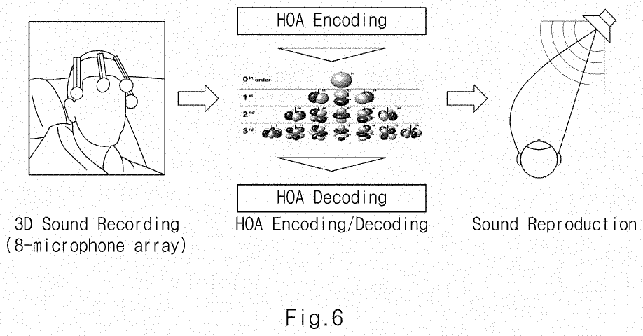

FIG. 6 is a diagram schematically illustrating a process of designing a sound corresponding to a virtual image according to embodiments of the present disclosure.

First, the processor 170 may record the 3D sound reproduced in the vehicle using the microphone 140. The processor 170 may measure the 3D sound for each position in the vehicle using at least one of an 8-channel microphone (8ch mic), an in-ear mic, a 32-channel microphone (32ch eigenmike), or a 2-channel microphone (2ch mic).

The processor 170 may perform the sound reproduction through the HOA encoding and decoding of the recorded sound. The HOA may be a method that may reproduce the three-dimensional sound by arranging speaker devices in a spherical shape centered on a listener. In first-order ambisonics, only a simple mode may be applied, so that reliability may be secured only for a low frequency. On the other hand, the higher-order ambisonics may be a technology that allows realistic sound to be realized even at a somewhat high frequency as various modes may be applied.

The HOA encoding may be a process of converting a format of data (the 3D sound) measured by the microphone 140 into a HOA format. As the HOA format, a B-format, which may be an Ambisonics standard format, may be applied. The B-format may contain non-directional volume information W and 3D direction information X, Y, and Z. The processor 170 converts a coordinate system of raw data of each microphone 140 from a coordinate system of the microphone 140 to a HOA coordinate system through the HOA encoding. The processor 170 may use a conversion equation like [Mathematical Equation 1] during the HOA encoding.

B=CP [Mathematical Equation 1]

thus:

P=C⁻¹B
B: Ambisonic channels B=[W X Y Z]^{T}
C: re-encoding matrix (N×L), the entries of C are the value of the spherical harmonics for the loudspeaker positions
P: the column vector of loudspeaker signals
C⁻¹: decoding matrix

The HOA decoding may be a process of converting the coordinate system of the data whose format may be converted to the HOA format from the HOA coordinate system to the coordinate system of the spherical speaker array. The processor 170 may generate a signal to be input to a speaker position to be implemented from the data in the B-format by applying a predetermined conversion code (a conversion equation). The processor 170 may use a conversion equation like [Mathematical Equation 2] during the HOA decoding.

$$[ Mathematical Equation 2 ]$$

$${p}_{j} = \frac{1}{L} [ \frac{1}{\sqrt{2}} W + X ( {cos∅}_{j} {cosθ}_{j} ) + Y ( {sin∅}_{j} {cosθ}_{j} ) + Z ( {sin∅}_{j} ) ]$$

$${p}_{j} : the signal feeding the j - th loudspeaker$$

$$L : the number of loudspeakers$$

The processor 170 may be configured to perform the sound reproduction using a head-related transfer function (HRTF). The HRTF may be applied when realizing the 3D sound with the headset because sound perception may be different for individuals based on structures and shapes of a head and ears and response characteristics may be different based on a frequency. As described above, an immersion personalization evaluation may be reduced by applying logic (e.g., the HRTF) in consideration of individualized body characteristics, so that it may be possible to improve a sensation of immersion cognitive characteristic for the virtual driving simulation.

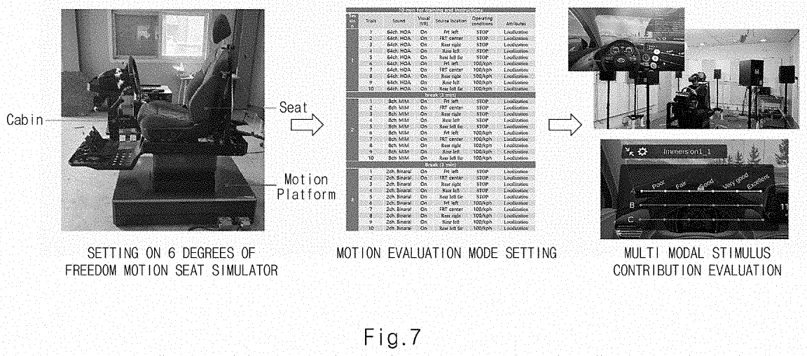

FIG. 7 is a diagram schematically illustrating a sound-based multi modal excitation process according to embodiments of the present disclosure.

Referring to FIG. 7, the processor 170 may set (tune) the seat simulator 150 based on a predetermined scenario. The processor 170 may perform the setting such that the motions of the 6 degrees of freedom may be driven by transmitting the parameter to the seat simulator 150.

The processor 170 may be configured to set the motion evaluation mode based on a sound-based visual and motion scenario. The processor 170 may be configured to generate the multi modal excitation by driving the seat simulator 150 in the set motion evaluation mode.

The processor 170 may be configured to perform the multi modal stimulus contribution evaluation. The evaluation mode may be set in consideration of a seat sitting posture to reduce an individualized evaluation in the immersion evaluation by the multi modal excitation.

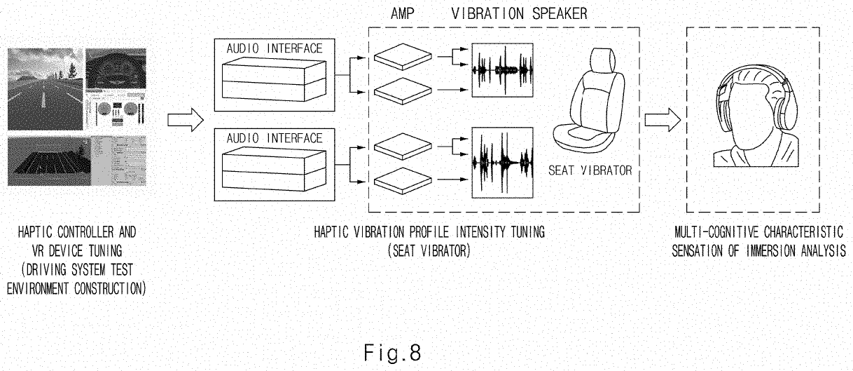

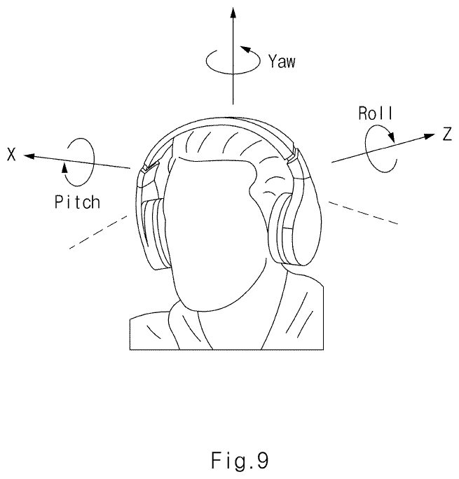

FIG. 8 is a diagram schematically illustrating a sound-based haptic stimulus influence analysis process according to embodiments of the present disclosure. FIG. 9 is a diagram illustrating a head rotation coordinate system according to embodiments of the present disclosure.

The processor 170 may be configured to construct a driving system test environment (the virtual environment) through the tuning of the haptic controller 160 and the VR device. The processor 170 may be configured to construct an environment for the sound-based tactile stimulus by examining a test mode, a road, the user, selection of a vehicle to be evaluated, a posture, and an evaluator optimal position setting screen.

The processor 170 may be configured to tune the haptic vibration profile intensity based on a visual change of the VR device. For the sound-based vibration haptics, the sound source may be excited through the vibrator installed in the back and the cushion of the seat passing through an audio interface, the amplifier, and the like. The haptic vibration profile intensity in the haptic controller 160 and the seat may be set to be realistic and set such that there may be no time delay based on the visual change of the VR device.

The processor 170 may be configured to analyze the multi-cognitive characteristic sensation of immersion using multi-cognitive characteristic sensation of immersion analysis logic. The processor 170 may be configured to control the haptic controller 160 to generate vibration (that is, a haptic stimulus and a tactile stimulus) of the tuned haptic vibration profile intensity. The processor 170 may be configured to analyze the haptic stimulus influence through sensation of immersion analysis on the haptic stimulus of the tuned haptic vibration profile intensity.

Correction logic in consideration of head rotation may be applied to the headset to improve the sensation of immersion cognitive characteristic for the virtual driving simulation. It may be difficult for the headset to distinguish front and rear directions and to be implemented such that HRTF measurement may be possible for each evaluator, but it may be advantageous in evaluation with an excessive motion. The multi-cognitive characteristic sensation of immersion analysis logic may apply an autonomous sensory meridian response (ASMR) concept. The multi-cognitive characteristics sensation of immersion analysis logic may contribute to the improvement of the sensation of immersion by applying the correction logic in consideration of the head rotation by linking the head rotation with a roll, a pitch, and a yaw based on a vehicle coordinate system. As such, as the correction logic considering a difference in left and right ears resulted from the head rotation may be reflected, the user (a driver) may perform the sensation of immersion analysis without feeling a sense of difference.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure may not be limited by the embodiments. The scope of the present disclosure should be construed as being covered by the scope of the appended claims, and all technical ideas falling within the scope of the claims should be construed as being included in the scope of the present disclosure.

The present disclosure generates the sound corresponding to the virtual image and implements the motion and the haptics based on the sound, so that it is possible to improve the sensation of immersion during the driving simulation in the virtual environment.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A virtual driving simulation device comprising:
a microphone for measuring a three-dimensional (3D) sound; and
a processor configured to:
record the 3D sound through the microphone,
analyze a sound realization influence by reproducing the recorded 3D sound through higher-order ambisonics (HOA) encoding and HOA decoding, and
realize a sensation of immersion based on a result of analyzing the sound realization influence.

2. The virtual driving simulation device of claim 1, wherein the processor is configured to convert a format of a data from the microphone into a HOA format through the HOA encoding.

3. The virtual driving simulation device of claim 2, wherein the HOA format is a B-format containing non-directional sound information and 3D direction information.

4. The virtual driving simulation device of claim 2, wherein the processor is configured to convert a first coordinate system of the data whose format is converted into the HOA format into a second coordinate system of a speaker array through the HOA decoding.

5. The virtual driving simulation device of claim 1, wherein the processor is configured to reproduce a reproduced sound that has undergone the HOA encoding and the HOA decoding using a head-related transfer function (HRTF).

6. The virtual driving simulation device of claim 1, further comprising:
a seat simulator for providing motions of 6 degrees of freedom,
wherein the processor is configured to:
tune the seat simulator based on a predetermined scenario,
set a motion evaluation mode based on a sound-based scenario, and
analyze a motion excitation influence through immersion evaluation by a multi modal excitation provided by the seat simulator in the set motion evaluation mode, and realize the sensation of immersion by reflecting a result of analyzing the motion excitation influence.

7. The virtual driving simulation device of claim 6, wherein the processor is configured to set the motion evaluation mode in consideration of a seating posture.

8. The virtual driving simulation device of claim 1, wherein the processor is configured to:
construct the virtual environment by tuning a haptic controller and a VR device;
tune a haptic vibration profile intensity based on a visual change of the VR device; and
analyze a haptic stimulus influence through sensation of immersion analysis on the tuned haptic vibration profile intensity, and realize the sensation of immersion by reflecting a result of analyzing the haptic stimulus influence.

9. The virtual driving simulation device of claim 8, wherein the processor is configured to perform the sensation of immersion analysis using a headset where correction logic considering head rotation is applied.

10. The virtual driving simulation device of claim 1, wherein the microphone is implemented as a multi-channel microphone.

11. A method for improving a sensation of immersion for a virtual driving simulation, the method comprising:
recording, by a processor, a 3D sound using a microphone;
reproducing a reproduced sound, by the processor, from the recorded 3D sound through HOA encoding and HOA decoding;
analyzing, by the processor, a sound realization influence through the reproduced sound; and
realizing, by the processor, a sensation of immersion based on a result of analyzing the sound realization influence.

12. The method of claim 11, wherein the reproducing of the recorded 3D sound includes:
converting a format of a data from the microphone into a HOA format through the HOA encoding; and
converting a first coordinate system of the data whose format is converted into the HOA format into a second coordinate system of a speaker array through the HOA decoding.

13. The method of claim 12, wherein the HOA format is a B-format containing non-directional sound information and 3D direction information.

14. The method of claim 11, wherein the reproducing of the recorded 3D sound includes:
reproducing a reproduced sound of the recorded 3D sound that has undergone the HOA encoding and the HOA decoding using a HRTF.

15. The method of claim 11, further comprising:
tuning a seat simulator for providing motions of 6 degrees of freedom based on a predetermined scenario;
setting a motion evaluation mode based on a sound-based scenario;
analyzing a motion excitation influence through immersion evaluation by a multi modal excitation provided by the seat simulator in the set motion evaluation mode; and
realizing the sensation of immersion by reflecting a result of analyzing the motion excitation influence.

16. The method of claim 15, wherein the setting of the motion evaluation mode includes:
setting the motion evaluation mode in consideration of a seating posture.

17. The method of claim 11, further comprising:
constructing the virtual environment by tuning a haptic controller and a VR device;
tuning a haptic vibration profile intensity based on a visual change of the VR device;
analyzing a haptic stimulus influence through sensation of immersion analysis on the tuned haptic vibration profile intensity; and
realizing the sensation of immersion by reflecting a result of analyzing the haptic stimulus influence.

18. The method of claim 17, wherein the analyzing of the haptic stimulus influence includes:
performing the sensation of immersion analysis using a headset where correction logic considering head rotation is applied.
